(19) United States
(12) Patent Application Publication
(10) Pub. No.: US 2012/0123958 A1
(43) Pub. Date: May 17, 2012

(54) Employer-candidate time and information manager

(76) Inventors: James C. D. Wahls, Detroit, MI (US); Tarik B. Green, Detroit, MI (US)

(21) Appl. No.: 13/373,197

(22) Filed: Nov. 8, 2011

Related U.S. Application Data
(60) Provisional application No. 61/456,926, filed on Nov. 15, 2010.

(51) Int. Cl. G06Q 10/06

(52) U.S. Cl. 705/321

(57) ABSTRACT

A method of online human resource management for hiring employers of prospective job applicants. First, job seekers may apply to an employment posting listed on a region-specific employment listing website by submitting a resume. Applicants are notified through an online messaging system when certain actions are taken by the employer or applicant. Second, employer may request an interview by initiating a direct connection with online applicant. The interview request is received through a messaging system and can be responded to by applicant through an online function. Thirdly, employer may request and retrieve additional documents such as cover letter and writing sample. The purpose of this system is to foster effective management of job applicants and to decrease the response time between online job application and feedback to job applicants.

This application claims the benefits of U.S. Provisional Application Ser. No. 61/456,926, filed on Nov. 15, 2010 and entitled “Employer-candidate time and information manager,” which is hereby incorporated by reference in its entirely.

### BRIEF DESCRIPTION OF THE INVENTION

This invention relates to a computerized, online human resource management approach. In particular, the present invention relates to a system and method to foster effective management of job applicants and to decrease the response time between applying for an online job listing and receiving feedback such as resume download notification and employer interview request.

### BACKGROUND OF THE INVENTION

Employers today heavily rely on online employment listing websites, also referred to as job search engines or job boards, on the Internet to market job openings, to recruit candidates, and to receive job application materials. When initially created, these websites immediately were fashioned as a low-cost, efficient way for employers to recruit and connect with qualified applicants. As a result, job search engines have now become a predominate way for employers to recruit job candidates.

However, as traditional, large job websites have grown expeditiously, user prices have grown tremendously and efficiency has waned. To post on traditional job boards can cost hundreds of dollars. In addition, due to the size of many job boards and their global reach, employers now receive too many resumes to process. Thus, job seekers have developed the sense that their online resumes are not being reviewed.

To combat this, there has been a dramatic shift in the online employment listing website market. Instead of relying on simple search filters within employment listing websites, job search engines are relying on more complex search algorithms in attempts to reduce the number of candidates through matching systems. These systems include a greater number of factors such as skill sets, career desires, personality traits, and others to dwindle the applicant pool to provide targeted candidates.

In addition, there has been a rise in features that include greater responsiveness such as when an application is received. Inclusion of these refined features results in higher quality candidates. Finally, there has been a rise in social networking applications that allow job seekers to use their own networks to make contacts and referrals to target companies easier.

However, with these improvements, the job search engine market still fails to address the needs of regional small businesses, governments, and nonprofits. Job and internship candidate searches for these entities excluding certain specializations tend to be regional in nature. Posting on international, general search engines is too costly and ineffective. Also, these entities do not receive a large number of candidates, so automated matching systems and social networking features may limit an applicant pool that is already too small. Furthermore, certain systems are exclusionary to the certain qualified but disadvantaged applicants that do not currently possess inherent networks. For small businesses, governments, and nonprofits, it is desirable to create a comprehensive regional-based candidate system for their job and internship applicant searches.

### SUMMARY OF THE INVENTION

The invention can be implemented as a method and as a system. The method and system for managing employment candidates online comprise, of providing the ability to list a job position on a region-specific, employment listing website, the ability for an applicant to apply to the posting by submitting a resume, receipt of notifications through an integrated messaging function and email, the allowing of the employer and the applicant directly communicate to agree upon an job interview time, and the ability for employers to request and download career-related documents. The invention also provides the ability to incorporate the agreed upon interview details into a certain computer file format.

### BRIEF DESCRIPTION OF THE DRAWINGS

For a better understanding of the invention, reference should be made to the following detailed description taken in conjunction with the accompanying drawings, in which:

FIG. 1 illustrates the definition of a region-specific, employment listing website through an exemplary display.

FIG. 2 illustrates an exemplary display of the system for executing the invention according to embodiments of the present invention.

FIG. 3 illustrates the messaging function that is included in the invention through a flow-diagram.

FIG. 4 illustrates the messaging interface that is included within a region-specific employment listing website through an exemplary display.

FIG. 5 illustrates an exemplary mirror email that is generated by the messaging function through an exemplary display.

FIG. 6 illustrates an online application feature user interface job addendum that is displayed once an applicant applies to a job listing through an exemplary display.

FIG. 7 illustrates the interview request screen of the user interface through an exemplary display.

FIG. 8 illustrates the interview receipt screen of the user interface through an exemplary display.

FIG. 9 illustrates the document request screen of the user interface through an exemplary display.

FIG. 10 illustrates document upload screen of the user interface through an exemplary display.

### DETAILED DESCRIPTION OF THE INVENTION

The invention relates to a method and system of online human resource management on a region-specific employment listing website. In this manner, employers can quickly identify job applicants, review their credentials, schedule interviews, and request additional documents. The invention also allows job applicants to receive faster feedback from employers including automated feedback from the method and system when an employer downloads his or resume and also through the interview and document request functions described below.

### Certain Definitions

For the purposes of this Detailed Description, an employment listing website is a website that allows “Users,” as defined below, through created account profiles, to upload a resume and/or optional information stored in a computer database for one of the following purposes: 1) to post employment opportunities to one or more viewable databases or 2) to view and apply to posted employment listings.

Users are hereby defined as either an “Employer” or “Candidate.” Employers are individuals, companies, or organizations that are seeking potential part-time workers, contractual workers, student interns, or full-time employees. Candidates (also referred to as “Applicants”) are individuals that are seeking an employment or internship opportunity.

“Job” refers to a full- or part-time job and also an internship. Finally, “job posting,” “employment listing,” and “job listing” are interchangeable.

### Region-Specific Employment Listing Website

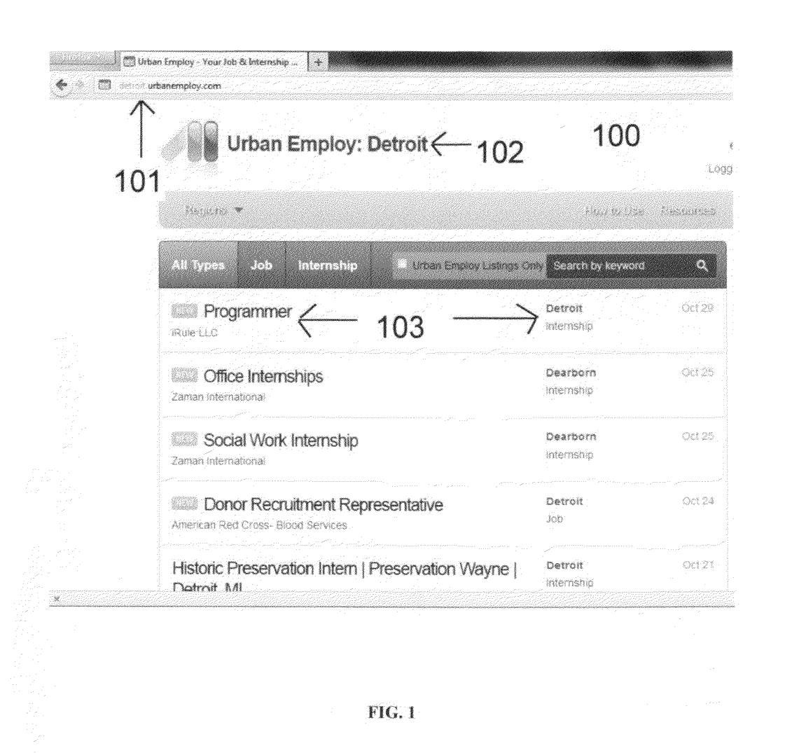

FIG. 1 illustrates a “region-specific employment listing website 100,” which is defined by certain characteristics. These characteristics include a location-specific feature within the website's internet domain or subdomain 101. The website expressly states what geographical region the employment listing website is serving 102. Furthermore, the employment listings must be geographically located in the defined region 103. It is understood that “region” may refer to a nation, state, province, or any other political subdivision.

A region-specific website is a critical element of this invention. Employment listings on traditional employment listing websites are generally filtered by region, but methodical separation by exclusionary websites significantly narrows the viewing pool to candidates interested in locating in the relevant geographical region. In addition, region-specific employment listing websites allow for more advanced search engine optimization. General job search engines rely on web crawlers and robots to “crawl” over websites to display relevant search results to users in ranking format. These sites, including Google and Bing, are primary tools used by job users to navigate the Internet. Region-specific employment listing websites result in higher search engine rankings when users search for jobs in specific regions.

### System

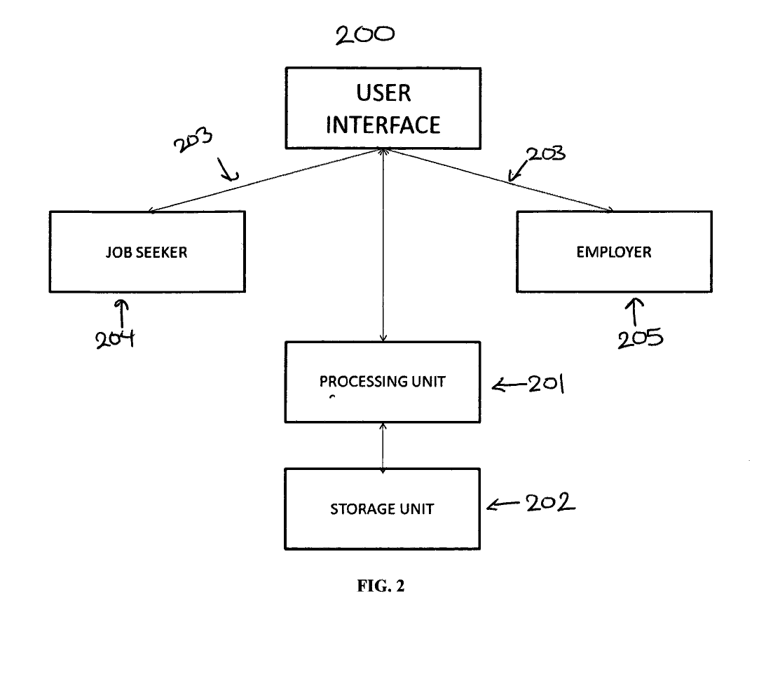

FIG. 2 illustrates an exemplary system 200 for executing the manager according to embodiments of the present invention. A system includes a server or processing unit 201, which hosts the region-specific employment listing website and the employer-candidate manager. The server can be a known server computer having a central processing unit (CPU) ad network interface. The memory can store data and programs for execution by the CPU. The system also includes storage unit 202, which holds database of the account profiles of both job applicants and employers and uploaded documents such as resumes and requested documents that are exchanged between employer and job applicants. The server communicates across a computer network with a user interface 203 to the viewing devices of job seeker 204 and employers 205, which can be any computer or Internet enabled mobile device with HTML-enabled web browser that is used by users to perform functions on the region-specific employment listing website.

In operation, the region-specific employment listing website that is hosted on the server provides an employer registration page that allows the employer to fill in the required fields to create an account. Account creation is necessary for the invention for verification purposes. Accounts also allow the server to track which candidates are applying for certain jobs, track which job listings are posted by employers, and allow for a candidate to have his or her uploaded resume and other documents to be identified by the invention when he or she applies to a position.

### Messaging Function

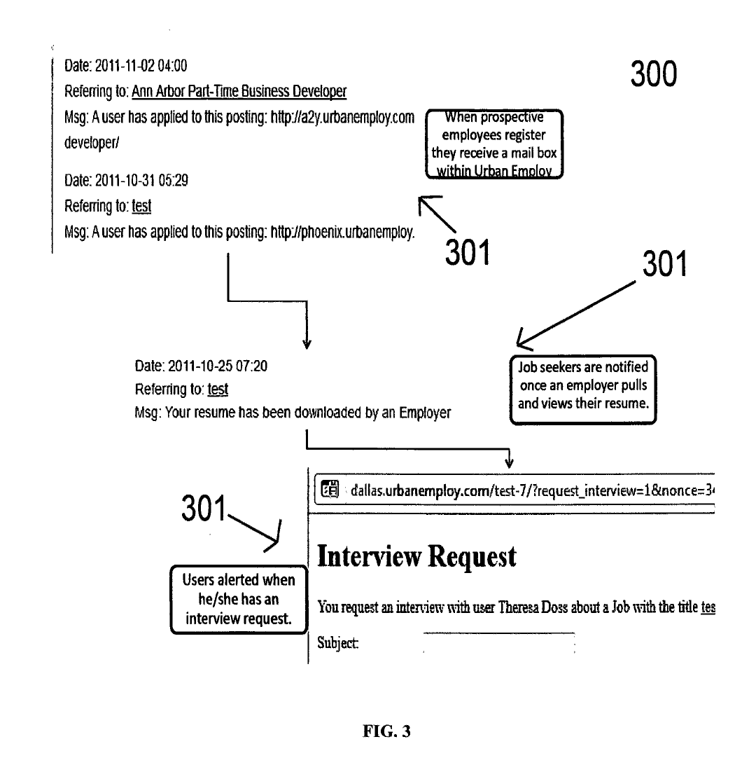

FIG. 3 illustrates the messaging function that is included in the invention through a flow-diagram 300. The messaging function is integrated in the user interface 104 of the region-specific employment listing website. The purpose of the messaging function is to notify job applicants and employers with certain notifications when certain acts are completed within the invention 301.

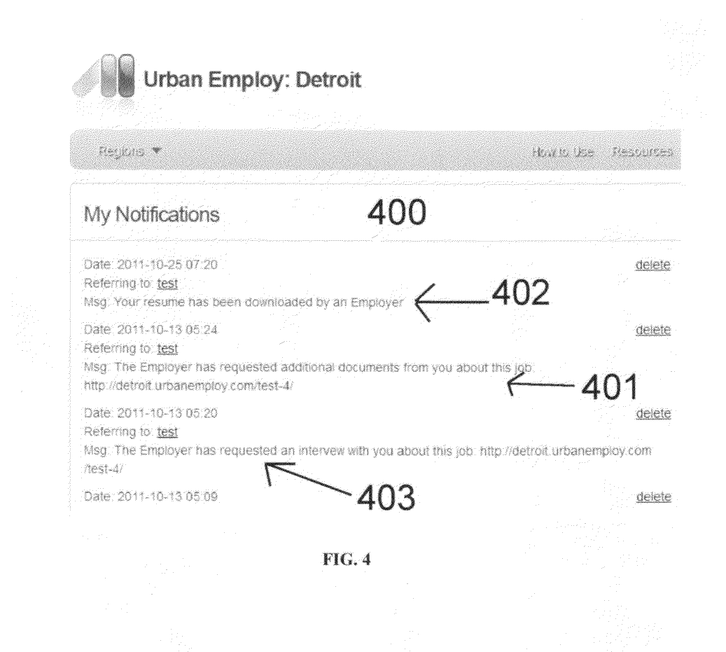

FIG. 4 illustrates an exemplary display of the messaging interface 400 that is included within a region-specific employment listing website. The messaging function generates notices 401 for job applicants such as, but not limited to, for when an employer downloads a candidate resume 402, and when an employer requests an interview 403. For employers, the messenger function generates notices such as, but not limited to, for when an applicant has applied to a job or an applicant has uploaded requested documents.

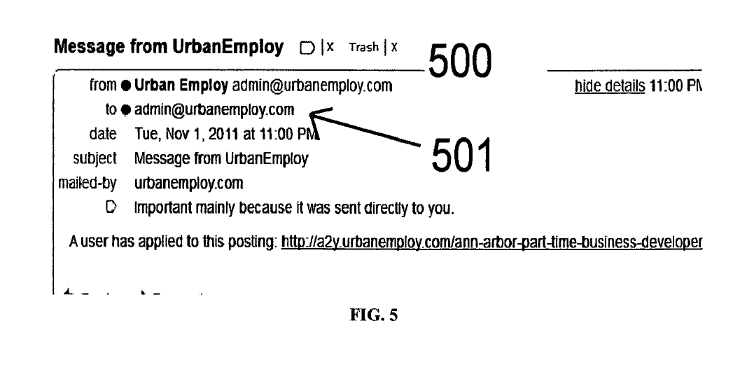

FIG. 5 illustrates an exemplary mirror email 500 that is generated by the messaging function. The messaging program automatically delivers these emails to the registered email address 501 of job applicants or employers. The purpose of these emails is to encourage the user to go to region-specific employment listing website and to notify either the job applicant or employer about user actions taken.

### Online Application

The online application feature initiates the invention by allowing the job applicant to apply to an employment listing by submitting a resume that is uploaded to the applicant's account profile on the region-specific employment listing website. The resume is stored within the database 202 that is organized by both employer and candidate account profile entries. When an employer lists a job, the employer proceeds to post its job listing on the website. A job listing includes name of company, job title, job description, education, experience requirements, salary and benefit expectations, job location and option for online application.

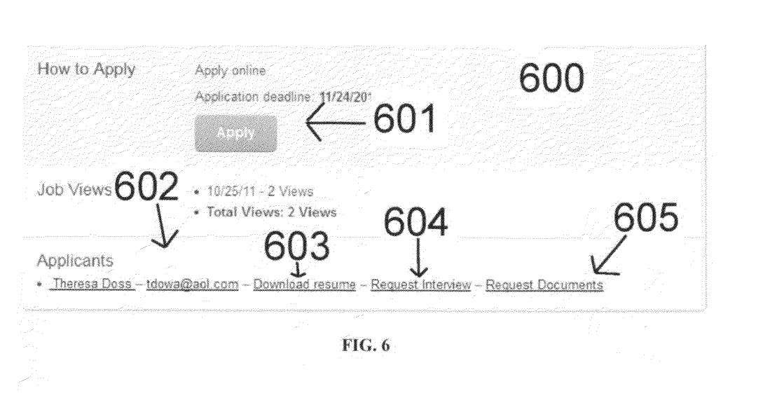

FIG. 6 illustrates an exemplary display of the online application feature 600 within the user interface that is displayed once an applicant applies to a job listing. The online application functionality operates through the following user actions. The job applicant views the listing and sees the on screen icon 601 to apply to the listing. Once the icon is clicked, the processing server attaches an addendum 602 to the job listing, which reflects that the applicant has applied for the listing. The addendum provides links to download the applicant's resume 603, to request an interview 604, and to request additional documents 605.

### Resume Download

After an applicant has applied to an employment listing online, the employer has the option 603 to download the applicant's resume to the employer's viewing device. Within the device's browser, the resume download program provides the option to download an electronic form of the resume, which can be in but not limited to Adobe format (.pdf) or Microsoft Word format (.doc, .docx).

The program then automatically notifies the applicant via a notification 402 in the messaging interface and email that an employer downloaded his or her resume. The intention of this notification is to encourage user loyalty, but it is also to encourage confidence in the candidate that the employer has received the resume.

### Interview Request

Another embodiment on the invention is the Interview Request program. When an applicant has initiated the online application, the employer then has the option to proceed to click on the “Request Interview” icon 604 within the user interface 600. This will initiate the processing server 201 to display an interview screen request screen.

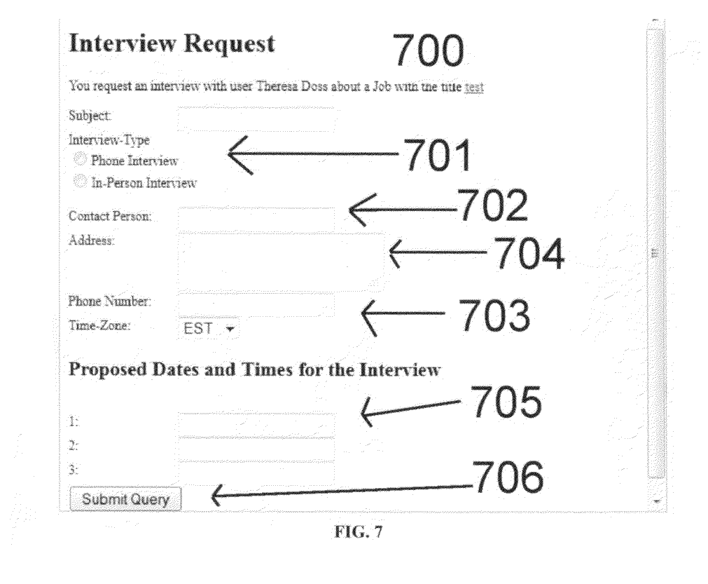

FIG. 7 illustrates an exemplary display of user interface 700 of the interview request screen. The screen includes input fields for interview type 701, contact person 702, contact phone number 703, contact address 704, and the option for three interview times 705. After the requesting employer sends the interview request by clicking the submit button 706, the job applicant is notified via the messaging function and email that the employer has requested an interview.

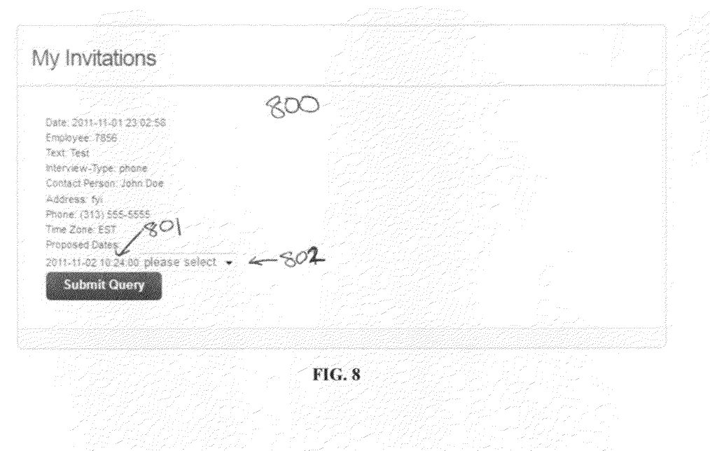

FIG. 8 illustrates an exemplary display of user interface for the interview receipt 800 that is received by the applicant. The applicant can accept the interview request by accepting 801 one of the time options. The applicant also has the ability to decline 802 an interview request. If the interview is accepted, then the employer is notified by the invention that the interview has been accepted either through the messaging function or a separate user interface screen. When an interview is agreed upon between Users, the employer may download an iCalendar (.ical) formatted file that incorporates the interview information to be synchronized with computer and web-based software used for scheduling, planning, and email for better candidate management.

### Document Request

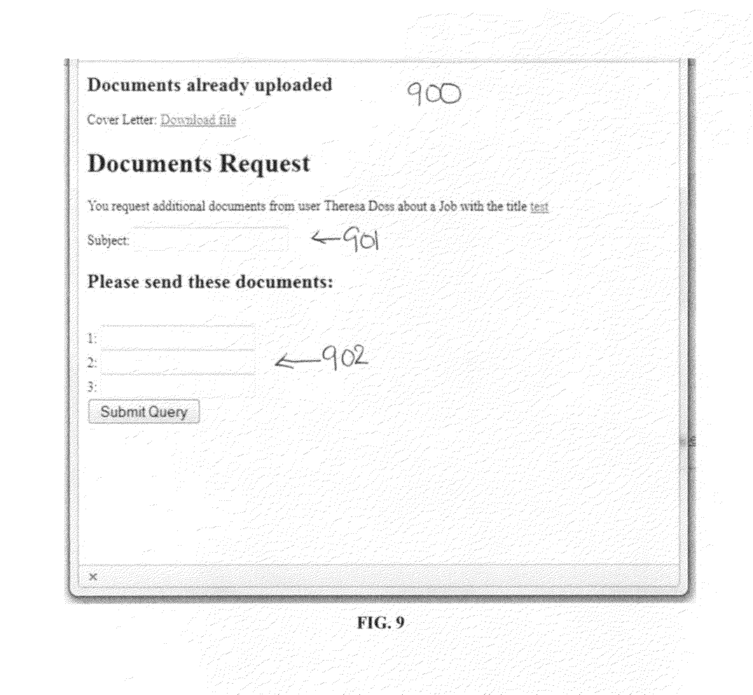

Within the user interface of the Online Application function, the employer can also select the “Request Documents” icon 405. When the employer clicks the icon, the processing server creates a screen that allows the employer to input which documents are being requested. FIG. 9 illustrates an exemplary display of the user interface 900 for the document request program that is created by the invention. The display includes a subject field 901 and a section to request requested documents 902.

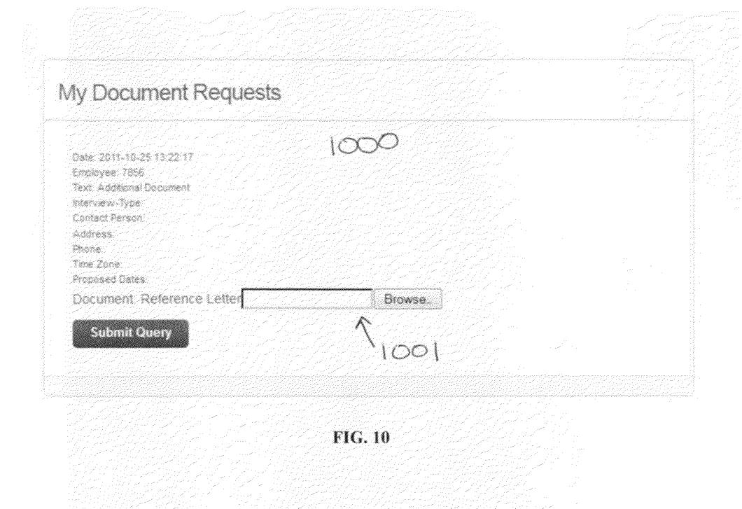

FIG. 10 illustrates document upload screen of the user interface 1000 through an exemplary display. After the employer submits a document request, the applicant is notified by the messaging function 406 that the employer has requested certain documents. The applicant then proceeds to the interface. The interface includes the ability to upload the electronic documents 1001 from the hard drive of the employer's viewing device.

Once the documents are uploaded, the messaging function then notifies the employer that the user has uploaded the requested documents. The employer then goes back to the job listing addendum and clicks on the “Request Document” option of the relevant candidate 405. There, the employer is able to download the additional documents 407.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed:

1. A method of online human resource management, comprising of:
Applying to a job on a region-specific, employment listing website, by submission of an electronic version of a resume;
Notifying the job applicant and employer of certain actions in relation to the invention;
Providing the option to employers to either download an applicant's resume, request an interview, or request additional documents;
Directly communicating through an online system to agree upon a job interview time; and
Allowing the employer to request and receive additional documents from a job applicant.

2. The method of claim 1, wherein the applying further comprises of at least a job addendum to a job listing on a region-specific employment listing website that provides employers the options of downloading the applicant's resume, requesting an interview, and requesting additional documents.

3. The method of claim 1, wherein the notifying further comprise of 1) creation of a messaging function within an region-specific, employment listing website that notifies of job applicant and employer of certain actions correlating to actions by the applicant or employer 2) a function that creates corresponding email notifications and 3) automatic notification to inform an applicant when an employer has downloaded his or her resume.

4. The method of claim 1, wherein the directly communicating further comprises of the ability to download an iCalendar (.ical) formatted file that includes the agreed upon interview information created by use of the invention to be synchronized with compatible computer and web-based software used for scheduling, planning, or electronic mail.
